(19) United States
(12) Patent Application Publication
(10) Pub. No.: US 2026/0111889 A1
(43) Pub. Date: Apr. 23, 2026

(54) SYSTEM AND METHOD FOR WIRELESS TAP TRANSACTIONS WITH A PHYSICAL INSTRUMENT AND MOBILE DEVICE

(71) Applicant: Block, Inc., Oakland, CA (US)

(72) Inventors: Gustaf Engstrom, San Francisco, CA (US); Ashutosh Dhodapkar, San Francisco, CA (US)

(73) Assignee: Block, Inc., Oakland, CA (US)

(21) Appl. No.: 18/921,692

(22) Filed: Oct. 21, 2024

Related U.S. Application Data
(63) Continuation of application No. 16/898,104, filed on Jun. 10, 2020, now abandoned.

(51) Int. Cl. G06Q 20/40; G06Q 20/32; G06Q 20/34

(52) U.S. Cl. CPC G06Q 20/40; G06Q 20/3255; G06Q 20/3278; G06Q 20/353

(57) ABSTRACT

An application at a mobile device displays a user interface with an amount. Responsive to receiving a user selection of a button at the mobile device, the application presents an indication to tap a physical instrument to the mobile device to conduct a transaction for the amount. A wireless communication module of the mobile device is activated to read data from nearby wireless communication modules. Based on a tap of a physical instrument to the mobile device, the wireless communication module of the mobile device wirelessly reads identifier information of the physical instrument from a wireless communication module of the physical instrument. Based on the read identifier information, the mobile device receives authorization to conduct the transaction between a first account associated with the physical instrument and a second account associated with the mobile device. The transaction is then initiated based on the authorization.

### BACKGROUND

Generally, splitting a bill for payment generally involves coordination between a merchant and multiple customers involved in a transaction. For example, at a restaurant the server must bring the bill to the table, the customer must determine a payment method and provide some physical form of payment (e.g., cash or transaction card). The server then returns to the table to collect the payment and, in situations in which the customer is paying using a transaction card, return to the table for the customer's signature.

Often, larger groups will desire to split the payment amongst a number of customers. This often requires a calculation of each individual's contribution, coordination of multiple payment methods and/or the coordination of payment between customers at the table. Many times customers will write down the amount owed on the back of the bill and provide multiple payment methods for the server to manage. Other times, customers will ask that the bill be split, requiring more time and energy from the server, who must recall which items each customer is responsible for.

### BRIEF DESCRIPTION OF THE DRAWINGS

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a payment service network according to one example as described herein;

FIG. 1B illustrates a payment service network according to one example as described herein.

FIG. 2 illustrates a mobile device and payment application according to one example as described herein.

FIG. 3A illustrates a method for splitting a bill according to one example as described herein.

FIG. 3B illustrates a method for splitting a bill according to one example as described herein.

FIG. 4A illustrates a method for splitting a bill according to one example as described herein.

FIG. 4B illustrates a method for splitting a bill according to one example as described herein.

FIG. 5A illustrates a graphical user interface according to one example as described herein.

FIG. 5B illustrates a graphical user interface according to one example as described herein.

FIG. 5C illustrates a graphical user interface according to one example as described herein.

FIG. 6 illustrates a graphical user interface according to one example as described herein.

FIG. 7 illustrates a flow chart of the split payment system according to one example as described herein.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology.

The disclosed technology addresses the need in the art for a payment service capable of securely and automatically splitting a recent transaction between users by transmitting identification data between payment apparatuses, such as computers, mobile devices, and even payment cards using wireless communication protocols. Specifically, the payment service described herein can facilitate sharing data related to a recent transaction, allowing a user to pay another user for a reimbursement amount determined by the payment service, while each user may have the ability to approve such a reimbursement amount. The payment service, according to some examples, can eliminate barriers to splitting a bill by providing ease of access to identification data, while maintaining the benefits of digital transactions. For example, the payment service-as the payment transaction service and the peer-to-peer payment provider can provide a uniform method for users to split a recent transaction while avoiding the effort of determining a reimbursement amount, manually fetching such an amount from each user, and transferring such financial details in a secure manner-all while maintaining the convenient and secure benefits of wireless near-field communication technology.

Prior bill splitting systems suffer from technical shortcomings. For example, in prior bill splitting systems, splitting a bill required the first user to enter the user name for reimbursement, identify the transaction to be split, determine the amount to be reimbursed, request the amount from a second user, wait for the second user to send the amount, and then perform additional tasks as well. With the present system, the second user simply taps their phone or card on the first user's phone and the bill splitting process automatically happens because the present system retrieves the last transaction (or future transaction if it is a pre-pay tab event) from a transaction activity log, and then split the bill accordingly. The present system streamlines the bill splitting process using the architecture (described in detail below) as the payment service for the purchase in conjunction with the mobile application for the payment service running on the first user's mobile device.

Specifically, the present technology permits a first user to pay a recent transaction using the payment service, while permitting the second user to initiate a splitting procedure with the first user using a convenient, localized, and secured method of sharing identification data (e.g., NFC, Bluetooth, or other wireless technologies) via a wireless communication protocol associated with a second user's physical payment card or a payment application executing on the second user's mobile phone. In this way, the technology removes strain on the payment service by reducing the number of network calls to/from the payment service. Similarly, the technology also removes technical barriers to splitting a transaction that might inhibit a second user from providing a timely reimbursement amount to a first user, while lifting the burden from the first user of fetching reimbursements from each of the one or more individual second users. For example, users may initiate an automated bill splitting procedure through the payment service and payment application before or after a transaction occurs using short-range wireless communication protocols. This reduces the number of network calls from the requesting user (e.g., rather than transmitting a server request to find users and send each a payment request), and provides confidence to the first user requiring reimbursement that he/she will be paid by the correct individual and without needing to follow-up with further network requests to each individual user.

Additionally, the present technology, through the use of a trusted payment service, can increase the security and privacy of splitting a transaction reducing the effort needed on the part of the users involved. For example, when splitting a bill at a POS device, if the merchant is asked to split a bill between multiple cards, the merchant is often frustrated with requests to apply different amounts to different payment instruments (e.g., debit cards, credit cards) leading to the risk of math errors, especially with a larger-sized group. This also exposes multiple user's sensitive credit card information to the merchant's staff and often leads to multiple receipts being printed with some amount of personal information. The present technology protects a user from such threats by securely and discretely sharing a user's identification data using a wireless communication protocol. This secure transfer of identification data using a convenient, localized, and secured method (e.g., NFC, Bluetooth, or other wireless technologies), facilitates a transfer of data without publicly exposing such data.

The present technology through the use of a trusted payment service can further streamline and improve the reliability of the data exchange needed to complete a transaction.

For example, when splitting a bill, if the user who pays the bill does not know someone in the group, they would need to exchange some credential (e.g., e-mail address, phone number, etc.) and learn which payment service (e.g., Paypal™, Zelle™, Venmo™, CashApp™, etc.) that is associated with that credential. Sometimes the credential may be incorrectly exchanged between users, leading to a misdirected payment or payment request and a longer process for reimbursement may result. The present technology improves on the prior processes for reimbursement/splitting by securely and discretely sharing a user's identification data digitally using a secure wireless communication protocol embedded in a user's mobile phone or payment card. This secure transfer of identification data using a convenient, localized, and secured method (e.g., NFC, Bluetooth, or other wireless technologies), facilitates a transfer of data between users who may not know each other's credentials without publicly exposing such data and further provides an immediate indication to users that the reimbursement has been handled.

Generally, prior bill splitting systems and methods (e.g., Venmo™, Splitwise™, Billr™, among others) require inefficient and excessive data exchanges between the first user (e.g., requesting user) and the one or more second users (e.g., splitting users), resulting in numerous network calls to and from the payment service in order to split the transaction. For example, these bill splitting systems may require the first user to manually enter a total or itemized summary of the transaction. As the payment service for the initial transaction and the payment service for splitting transaction between users, the present technology provides a unique architecture for facilitating transactions as a payment service between the first user and the merchant, while allowing second users to split the transaction using data associated thereto. As a technological improvement over prior payment systems, the present payment service fetches transaction details from the account records associated with the first user and intelligently determines reimbursement amounts using the same transaction details. This reduces strain on the server executing the payment service by limiting the number of network calls to the payment service and reducing the bandwidth required by the payment service network to facilitate such a bill splitting process.

Even after a user uploads or otherwise submitting transaction data, prior bill splitting systems and methods may further require the first user to search for or otherwise manually identify second users in order to send each second user a request for reimbursement. The present technology minimizes the network calls for each individual second user by allowing the second users to identify themselves to the first user using secure wireless communication protocols. In doing so, the present technology simplifies the bill splitting process for the first user and second users, while reducing network calls required to facilitate such a bill splitting process.

The present technology may further permit a second user to reimburse the first user using multiple currencies of their choice, while the first user may receive the reimbursement in one or more currencies of their choice. Currency may include fiat currency, cryptocurrency, equity value, or other monetary value represented by digital assets. Examples of fiat currency may include, but are not limited to, the US Dollar, European Euro, Chinese Yuan, Japanese Yen, British Pound, as well as other government-backed currencies. Examples of cryptocurrency may include, but are not limited to, Bitcoin, Ethereum, Litecoin, Ripple, as well as other cryptography-supported digital assets. Examples of equity value may include, but are not limited to, stockholder equity, common/preferred stock, as well as other means of owning non-cash value.

The following description provides specific details for a thorough understanding and an enabling description of these implementations. One skilled in the art will understand, however, that the disclosed system and methods may be practiced without many of these details.

Additionally, some well-known structures or functions may not be shown or described in detail, so as to avoid unnecessarily obscuring the relevant description of the various implementations.

The terminology used in the description presented below is intended to be interpreted in its broadest reasonable manner, even though it is being used in conjunction with a detailed description of certain specific implementations of the disclosed system and methods. Some frequently used terms are now described.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “may,” “can,” “could,” or “might” be included or have a characteristic, that particular component or feature is not required to be included or have the characteristic.

The term “module” refers broadly to software stored on non-transitory storage medium (e.g., volatile or non-volatile memory for a computing device), hardware, or firmware (or any combination thereof) modules. Modules are typically functional such that they that may generate useful data or other output using specified input(s). A module may or may not be self-contained. An application program (also called an “application”) may include one or more modules, or a module may include one or more application programs.

The preceding summary is provided for the purposes of summarizing some examples to provide a basic understanding of aspects of the subject matter described herein. Accordingly, the above-described features are merely examples and should not be construed as limiting in any way. Other features, aspects, and advantages of the subject matter described herein will become apparent from the following description of Figures and Claims.

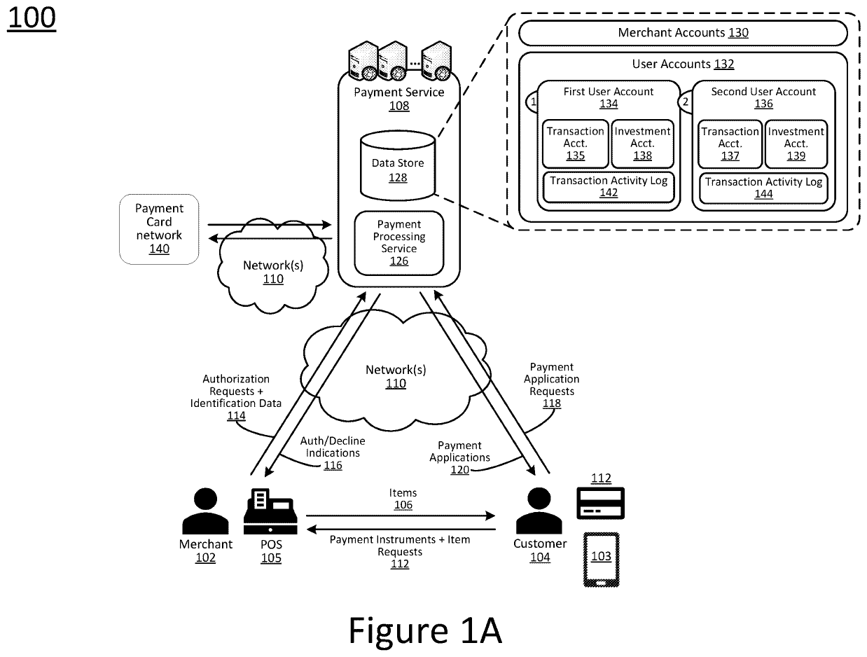

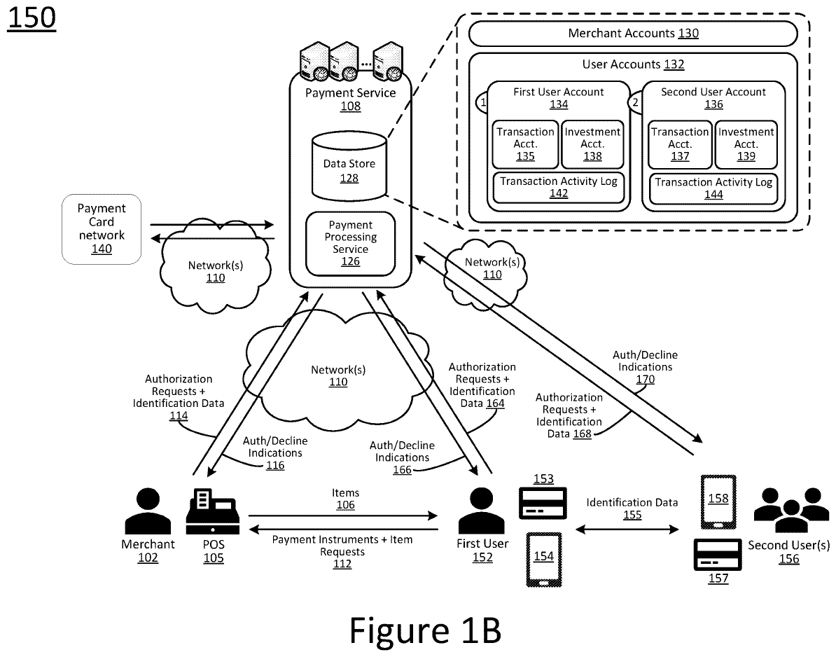

FIG. 1A illustrates a payment service network 100 in accordance with one example embodiment. According to one example, payment service network 100 includes merchant 102 that conducts transactions with customer 104 (or user 104) for items 106 (e.g., goods or services) offered by the merchant 102. FIG. 1 also illustrates a payment service system 108 (also referred to as payment service herein), coupled to a merchant point of sale (POS) device 105 and customer device 103 via a network 110, to authorize payment instruments of customer 104.

Customer 104 may engage in transactions with merchant 102 to obtain items 106. Customer 104 may provide, as shown at 112, payment instruments to merchant 102 along with requests for items 106 offered by merchant 102.

Merchant 102 may utilize POS device 105 for accepting payment from customer 104. POS device 105 may be any mobile or non-mobile device that includes instances of a POS application that executes on the device. POS device 105 may further include a wireless communication module with wireless communication capabilities (e.g., NFC, Bluetooth, cellular data, etc.), allowing wireless communication between POS device 105 and other devices with wireless communication capabilities. For example, POS device 105 may have an NFC-enabled chip that communicates with other NFC-enabled devices. The POS application may be provided by the payment service 108 and provide POS functionality to POS device 105 to enable merchant 102 (e.g., owners, employees, etc.) to accept payments from customers 104. In some types of businesses, POS device 105 may correspond to a store, restaurant, website, or other place of business of the merchant, and thus, may be a fixed location that typically does not change on a day-to-day basis, or internet commerce site. In other types of businesses, however, the location of POS device 105 may change from time to time, such as in the case that a merchant operates a food truck, is a street vendor, is a cab driver, etc., or has an otherwise mobile business, e.g., in the case of a merchant who sells goods or services at buyers'homes, places of business, and so forth.

As used herein, a merchant may include any business engaged in the offering of goods or services for acquisition by customers. Actions attributed to a merchant may include actions performed by owners, employees, website servers, or other agents of the merchant, and thus no distinction is made herein unless specifically discussed. In addition, as used herein, a customer 104 may include any entity that acquires goods or services from a merchant, such as by purchasing, renting, leasing, borrowing, licensing, or the like. Hereinafter, goods and/or services offered by merchants may be referred to as items, e.g. item 106. Thus, a merchant and a customer may interact with each other to conduct a transaction in which the customer acquires item 106 from merchant 102, and in return, customer 104 provides payment 112 to merchant 102.

As used herein, a transaction may include a financial transaction for the acquisition of item(s) that is conducted between customer 104 and merchant 102. For example, when paying for a transaction, customer 104 can provide the amount that is due to the merchant using cash or other payment instrument 112 (e.g., a debit card, a credit card, a stored-value or gift card, a check, through an electronic payment application on device 103 carried by the customer, or the like). The merchant can interact with POS device 105 to process the transactions, such as by inputting (e.g., manually, via a magnetic card reader, NFC reader, or an RFID reader, etc.) identifiers associated with payment instrument 112. For example, a payment instrument of the customer may include a card having one or more magnetic strips for providing card and customer information when swiped in a card reader. In other examples, other types of payment instruments may be used, such as smart cards having a built-in memory chip that is read by the device when the card is inserted into the reader, such as chips that comply with the Europay, MasterCard, Visa (EMV) standard (e.g., EMV cards). In other examples, other types of payment instruments include cards or computing devices that communicate via radiofrequencies such as a radiofrequency identification tags, and near field communication devices, etc.

During the transaction, POS device 105 can determine transaction information describing the transaction, such as an identifier of the payment instrument (e.g., payment card number, account credentials, or other payment device identifier), an amount of payment received from the customer, the item(s) acquired by the customer, a time, location (e.g., street address, GPS coordinates, IP address, etc.) and date of the transaction, a payment card network 140 associated with the payment instrument, an issuing bank of the payment instrument, a name or user account of the customer, contact information of the customer, type of the currency, IP address of POS device 105, IP address of customer device 103, and so forth. POS device 105 can send the transaction information to payment service 108 over network 110, either substantially contemporaneously with the conducting of the transaction (in the case of online transactions) or later when POS device 105 is in the online mode (in the case offline transactions).

In an offline transaction, POS device 105 may store information related to the transaction, including, but not limited to, a cost of the transaction, a time of day at which the transaction occurred, a day of the week at which the transaction occurred, a location at which the transaction took place, an item that the customer obtained, an identity and/or contact information of the customer, and a payment instrument used in the transaction. After conducting an offline transaction with customer 104, POS device 105 may provide at least a subset of the stored information to the payment service 108 over the network 110. The network 110 may represent any one or more wired or wireless networks, such as a Wi-Fi network, a cellular network, or the like. In an online transaction, POS device 105 may send this information to payment service 108 over network 110 substantially contemporaneously with the transaction with the customer.

After merchant 102 receives the payment information from customer 104, merchant 102 may send respective authorization requests, along with information related to the respective transactions, to payment service 108, as illustrated at 114. Payment service 108 may include payment processing service 126 and data store 128 that stores merchant accounts 130 and user accounts 132, as well as the transaction histories of merchants and users.

The payment processing service 126 may function to receive the information regarding a transaction from POS device 105 of merchant 102 and attempt to authorize the payment instrument 112 used to conduct the transaction. Payment processing service 126 may then send an indication of whether the payment instrument has been approved or declined back to POS device 105, as illustrated at 116.

Generally, when a customer 104 and a merchant 102 enter into an electronic payment transaction, the transaction is processed by electronically transferring funds from a financial account associated with the customer 104 to a financial account associated with the merchant 102. As such, the payment processing service 126 may communicate with one or more computing devices of a payment card network 140 (e.g., MasterCard®, VISAR) over network(s) 110 to conduct financial transactions electronically. Payment processing service 126 can also communicate with one or more computing devices of one or more banks, processing/acquiring services, or the like over the network 110. For example, payment processing service 126 may communicate with an acquiring bank, an issuing bank, and/or a bank maintaining user accounts for electronic payments. Payment processing service 126 may also communicate with, or access user and merchant accounts maintained by payment service 108.

An acquiring bank may be a registered member of a card association (e.g., Visa®, MasterCard®), and may be part of a payment card network 140. An issuing bank may issue credit cards to buyers (e.g., customer 104) and may pay acquiring banks for purchases made by cardholders (e.g., customer 104) to which the issuing bank has issued a payment card.

Accordingly, in some examples, the computing device(s) of an acquiring bank may be included in the payment card network and may communicate with the computing devices of a card-issuing bank to obtain payment. Further, in some examples, the customer 104 may use a debit card instead of a credit card, in which case, the bank computing device(s) of a bank corresponding to the debit card may receive communications regarding a transaction in which the customer is participating. Additionally, there may be computing devices of other financial institutions involved in some types of transactions or in alternative system architectures, and thus, the foregoing are merely several examples for discussion purposes.

While FIG. 1A illustrates merchants 102 sending the transaction data directly to the payment service 108 as part of the request to authorize the payment instrument 112, in some instances other entities (e.g., banks associated with the merchant 102 or with customer payment instruments 112) may provide transaction data, such as part of a batched, periodic process.

According to one example, data store 128 may be used to store merchant accounts 130 and user accounts 132, among other data. User accounts 132 may store records of user accounts associated with each user of payment service 108. For example, user accounts 132 may include a first user account 134 and a second user account 136. Each of the accounts of user accounts 132 may include information related to the respective balance and transaction history associated with each user account. Each of the accounts of user accounts 132 may include one or more balances associated with a payment service and further include access to external bank accounts. For example, first user account 134 includes transaction account 135 and investment account 138. As a further example, second user account 136 includes transaction account 137 and investment account 139. According to one example, transaction accounts 135 and 137 may include stored balances maintained by payment service 108 on behalf of its users. Investment accounts 138 and 139 may be used by users to save a stored balance towards a particular goal or otherwise to allow payment service 108 to maintain an investment on behalf of its users. Each user account 134 and 136 of user accounts 132 may also include a loan account representing funds that are loaned to the user by the payment service 108. Each user account 134 and 136 of user accounts 132 may further include access to external payment card networks (e.g., payment card network 140) to facilitate transactions with credit cards, debit cards, and the like.

Furthermore, transaction history for each user account may be stored using an individual log for each user account. For example, first user account 134 includes transaction activity log 142 and second user account 136 includes transaction activity log 144. Transaction activity logs 142 and 144 may be used to store transaction history for each respective user account, including debits and credits made to the balances thereof. Similarly, transaction history for merchants may be stored in merchant accounts 130 using an individual log for each merchant.

According to one example, each of the accounts of user accounts 132 may include stored values of multiple currencies, such as fiat currency, cryptocurrency, equity value, or other monetary value represented by digital assets. Each of the currencies may be stored directly in each account of user accounts 132. Each of the accounts of user accounts 132 may further include access to external accounts that facilitate such currencies (e.g., third party cryptocurrency exchanges/wallets, equity holding accounts, etc.).

According to one example, merchant accounts 130 may store information associated with respective ones of the merchants 102. For instance, the merchant accounts 130 may indicate a class of items offered by respective merchants (e.g., coffee items, collectibles, apparel, etc.), a type of business of the merchant (e.g., restaurant, coffee shop, retail store, etc.), a geographical location of the merchant, and the like.

In some instances, a computing device associated with the merchant (e.g., POS device 105, servers of the merchant, etc.) determines when the customer visits physical premises or a digital presence of the merchant. For instance, the device 103 of the customer 104 may include an application (e.g., an application provided by payment service 108) that communicates with POS device 105 of merchant 102 via near-field communication protocols (e.g., NFC, Bluetooth, etc.). Therefore, when the customer visits the physical premises of merchant 102, for example, POS device 105 may detect the presence of customer device 103. The POS device 105 may accordingly determine that the customer 104 is present. In another example, one or both of POS device 105 and customer device 103 may share its location (e.g., GPS coordinates) to a common service for determining when customer device 103 and POS device 105 are located within a proximity threshold of one another, and for mediating a transaction between customer device 103 and POS device 105.

In another example, customer 104 may utilize customer device 103 to check in at the merchant location, and POS device 105 may receive an indication of this check in. When the customer visits a digital presence of merchant 102 (e.g., mobile app, website, etc.), customer 104 may log in or otherwise provide information (e.g., a cookie on the device 103) from which the merchant 102 determines that the customer 104 is at the merchant location. Of course, while a few examples are listed, it is to be appreciated that the merchant 102 and/or payment service 108 may determine when the customer 104 is present at the merchant location in any other number of ways. In each instance, after payment service 108 receives an indication that customer 104 is co-located with merchant 102, the payment service 108 may determine whether to send one or more previously expressed item preferences of the customer 104 to the merchant 102.

In addition, customer 104 may desire to receive an instance of a payments application, such as a mobile wallet application, from the payment service 108. FIG. 1A illustrates that the customer 104 may send payment-application requests 118 to payment service 108. In response, payment service 108 may provide instances of the application 120 back to customer device 103. In addition, payment service 108 may map an identification of the instance of the application 120 to the user accounts 132.

FIG. 1B illustrates a payment service network 150 in accordance with one example embodiment. Payment service network 150 resembles payment service network 100 except that in FIG. 1B another transaction is shown between a first user 152 (e.g., customer 104) operating a first payment instrument, such as first payment card 153 and first mobile device 154, and a second user 156 operating a second payment card 157 and second mobile device 158. Mobile devices 154 and 158 can be a computing device with a wireless communication module with wireless communication capabilities (e.g., NFC, Bluetooth, cellular data, etc.), allowing wireless communication between other devices with wireless communication capabilities. Mobile devices 154 and 158 may further include an application provided by payment service 108 executing thereon. According to one example, the application can be a point of sale application provided by the payment service or a third-party entity. The application can also be a mobile wallet application and/or an application provided by a third party capable of accessing at least one payment account. According to one example, payment cards 153 and 157 may be associated with the associated user accounts 133 and 136 respectively as provided by payment service 108. Similar to mobile devices 154 and 158, payment cards 153 and 157 may also include a wireless communication module with wireless communication capabilities, such as that provided by near-field communication (NFC) technologies. Payment cards 153 and 157 may communicate with other apparatuses with wireless communication capabilities (e.g., NFC, Bluetooth, cellular data, etc.), such as mobile devices 154 and 158.

FIG. 1B illustrates that the present technology allows for currency to be transmitted between any two parties using the innovations described herein. For example, payment card 153 of the first user 152 may communicate with second mobile device 158 of the second user 154 using wireless communication (e.g., NFC) to transmit identification data 155. Similarly, first mobile device 154 of the first user 152 may communicate with payment card 157 of the second user using wireless communication to transmit identification data 155. Identification data 155 may also be wirelessly transmitted between any two devices, such as first mobile device 154 and second mobile device 158 or payment card 153 and payment card 157.

After receiving identification data 155, mobile devices 154 and 158 may transmit by network(s) 110 to payment service 108 the identification data 155 recently received from the other user, along with an authorization request to initiate a transaction at 164 and 168 respectively. After validating identification data 155 to identify the other user in user accounts 132, payment service 108 may provide authorization indications at 166 and 170 to mobile devices 154 and/or 158 in order to confirm that a user associated with the identification data 155 has been found in user accounts 132. According to one example, authorization indications at 166 and 170 may further include notification requests for the users to confirm details associated with the authorized transaction.

According to one example, once first user 152 and merchant 102 complete a transaction, first user 152 may receive a reimbursement message from second user 156. Once the transaction is complete, second user 156 may provide, using wireless communication (e.g., NFC), identification data 155 associated with the second user 156 from a second payment card 157 to first mobile device 154 of the first user 152, according to one example. The first mobile device 154 may then transmit identification data 155 as an authorization request 164 over network(s) 110 to payment service 108. According to one example, the first mobile device may transmit authorization requests and identification data 164 immediately after reading from second payment card 157 associated with second user 156. Alternatively, identification data may be transmitted after the first user confirms using the GUI of the first mobile device. An authorization indication 166 may be received at the first mobile device 154 from the payment service 108 and presented to the first user 152 as a GUI. According to one example, authorization indications 166 may include a notification to request confirmation from first user 152.

After receiving identification data 155 associated with the second user 156, the payment server may transmit to second mobile device 158 authorization indication 170 including a notification to request confirmation from second user 156 to split the transaction. Upon receiving the notification, second user 156 may confirm the request to split the transaction using second mobile device 158. In doing so, the second mobile device may transmit to payment service 108 a confirmation of the request in the form of authorization 168. According to one example, first mobile device 154 and second mobile device 158 may receive a notification from the payment service 108 that the reimbursement amount has been transmitted from the second user account 136 to the first user account 134, deducting the reimbursement amount from the second user account 136 and depositing into the first user account 134.

According to one example, authorization indications 166 and 170 may be transmitted to first mobile device 154 and second mobile device 158 respectively using other communication methods (e.g., email, SMS/MMS message(s), etc.). According to another example, authorizations 164 and 168 may be transmitted to payment service 108 from first mobile device 154 and second mobile device 158 using the other communication methods as indicated above.

Payment service 108 may facilitate real-time reimbursement transactions, allowing second user 156 to pay in any currency of their choice, while first user 152 may receive payment in a currency of their choice. Currency may include fiat currency, cryptocurrency, equity value, or other monetary value represented by digital assets. Examples of each currency are provided above. For example, second user 156 may submit a payment in cryptocurrency to first user 152. Upon receiving notification of payment, first user 152 may receive the cryptocurrency or the value of the cryptocurrency payment provided by second user 156 in US Dollars.

Payment service 108 may also facilitate real-time reimbursement transactions that allow second user 156 to request from first user 152 a loan with predetermined or custom contract conditions. For example, if second user 156 discovers that the associated account (e.g., second user account 136) has insufficient funds after receiving a request to split a transaction from first user 152, an option to request a loan may be presented to or requested by second user 156. Loans with predetermined contract conditions may be provided to either user in the event that a loan may need to be facilitated. These predetermined contract conditions may be set by payment service 108, including a predetermined time frame and a suggested interest rate and based on transaction history associated with the lending user and stored by the payment service, according to one example. For example, the payment service may determine that the second user can afford to pay weekly or monthly loan installments at a certain interest rate based on the second user's income flow and previous transactions occurring through payment service.

According to another example, a loan with custom contract conditions may be designed by first user 152, second user 156, or another user. These custom contract conditions may be further enabled by a drafting procedure provided by payment service 108 and facilitated by first mobile device 154 and/or second mobile device 158. The option to request a loan may be a feature provided by payment service 108 to be facilitated through a user's mobile device (e.g., first mobile device 154, second mobile device 158). First user 152 may approve or deny a request for a loan using first mobile device 154.

Payment service 108 may facilitate real-time reimbursement transactions, allowing users (e.g., first user 152, second user 156) to read the transaction information directly from POS device 105 of merchant 105 or a receipt produced therefrom. For example, POS device 105 may print a receipt once a transaction with first user 152 is complete. The receipt may have printed thereon a code (e.g., QR code or other visual tag) that, when scanned by a mobile device, transmits to that mobile device transaction information associated with the respective transaction. This code may also be digitally presented to a user by a graphical user interface of POS device 105 or otherwise displayed on POS device 105 for displaying to users.

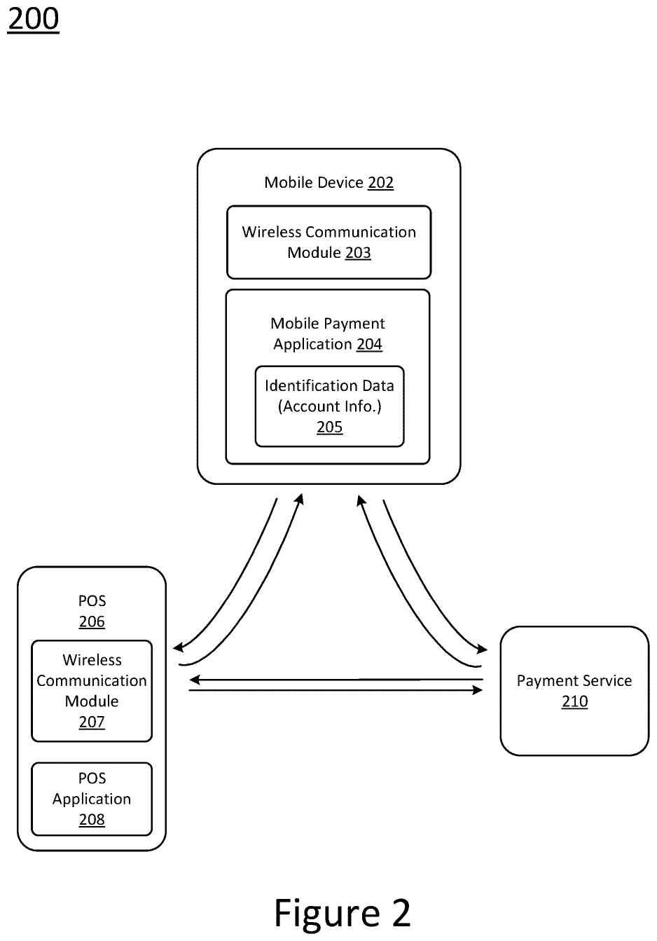

FIG. 2 illustrates a mobile device and payment application 200 in accordance with one example embodiment. Mobile device 202 and POS device 206 may be computing devices with wireless communication modules 203 and 207, respectively, with wireless communication capabilities (e.g., NFC, Bluetooth, cellular data, etc.), allowing wireless communication therebetween. A payment application 204 is a payment application provided by the payment service 210 and executes on a user's mobile device 202. POS device 206 can include a Point of Sale (POS) application 208 that is associated with one or more merchant systems and can be used by the customer to purchase products or services. The payment application 204 and POS application 208 can also be a website provided by payment service 210 (e.g., payment service 108), or any source website or application that provides a portal to send and accept payments for transactions using payment service 210. Applications 204 and 208 may be accessible through a web browser (e.g., Chrome® or Safari®) on the mobile device 202, according to one example. In another example, applications 204 and 208 can be software applications downloadable via an application store (e.g., Google Play Store®, Apple App Store®, etc.). Once accessed or registered into the applications 204 and 208, the web browser or application may remember the credentials (e.g., identification data 205) for subsequent visits (for example, through web browser authentication, web cookies, web history, etc.), allowing access to the applications without logging-in to an account again. The description herein is with reference to the payment application 204 and POS application 208 as installed applications; however, it will be understood that these applications as authenticated or unauthenticated applications on a web browser is within the meaning of the term.

Payment application 204 can include an electronic wallet application, money transfer application (e.g., application for sending and receiving money via email or phone), or any other application having stored therein identification data 205 linked to user accounts of payment service 210 or other data linked to one or more payment cards and/or bank accounts, both of which may be used by the owner of the mobile device to initiate transactions. Such transactions can include traditional purchase transactions between customers and merchants or service providers, person-to-person transactions, and the like.

Payment application 204 can also be used to manage internal payment cards (i.e., payment cards issued by payment service 108 to users having a user account 132). As such, options with respect to internal payment cards can be adjusted and managed using payment application 204. For example, when a user account of user accounts 132 includes multiple payment methods (e.g., credit card, bank account, loan account, etc.), payment application 204 can set one of those payment methods to be the default method for debits or credits when using an internal payment card.

Collectively, all tools for offering payment are herein referred to as payment instruments. For example, payment instruments can refer to mobile device 202 running payment application 204, internal payment cards, external payment cards, NFC-enabled payment cards, etc. The use of the term payment instrument does not imply a mechanism of use. For example, mobile device 202 may be utilized via NFC protocols (e.g., NFC Data Exchange Format (NDEF), NFC tags, etc.), or via use of software on mobile device 202 to send messages through web forms, applications, APIs, or messaging applications. As an additional example, payment cards, whether internal or external, can be presented to a merchant to be read, or a card number can be entered into a terminal under the control of the merchant or under the control of the customer. A payment instrument can include multiple payment instruments, such as when utilizing mobile device 202 to enter a payment card number. Throughout this description, specific payment instruments may be discussed, however, the specific payment instrument should not be considered limiting, and persons of ordinary skill in the art will appreciate instances in which a payment instrument such as a payment card can be substituted for another payment instrument such as a mobile device, and vice versa.

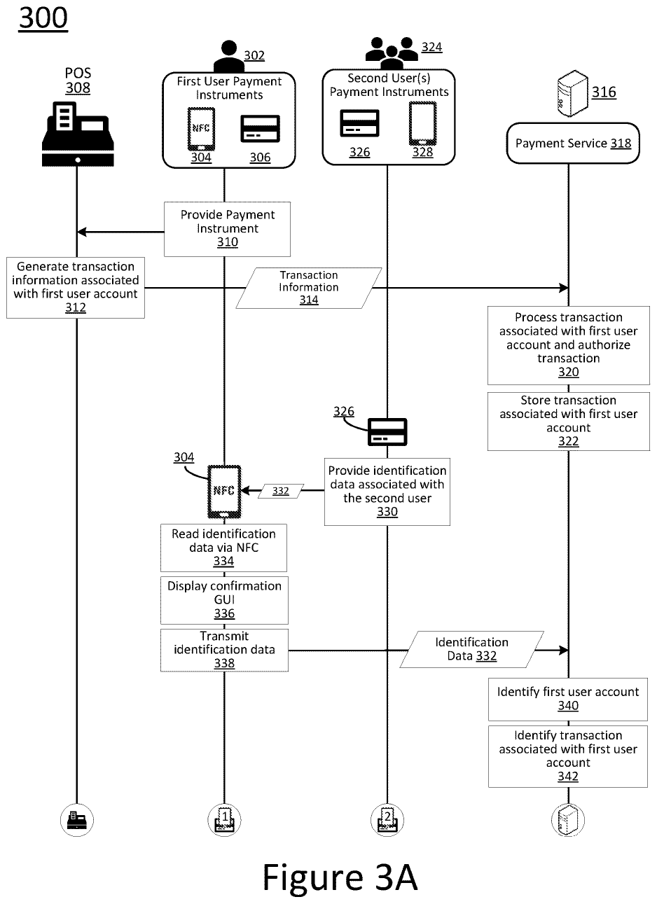

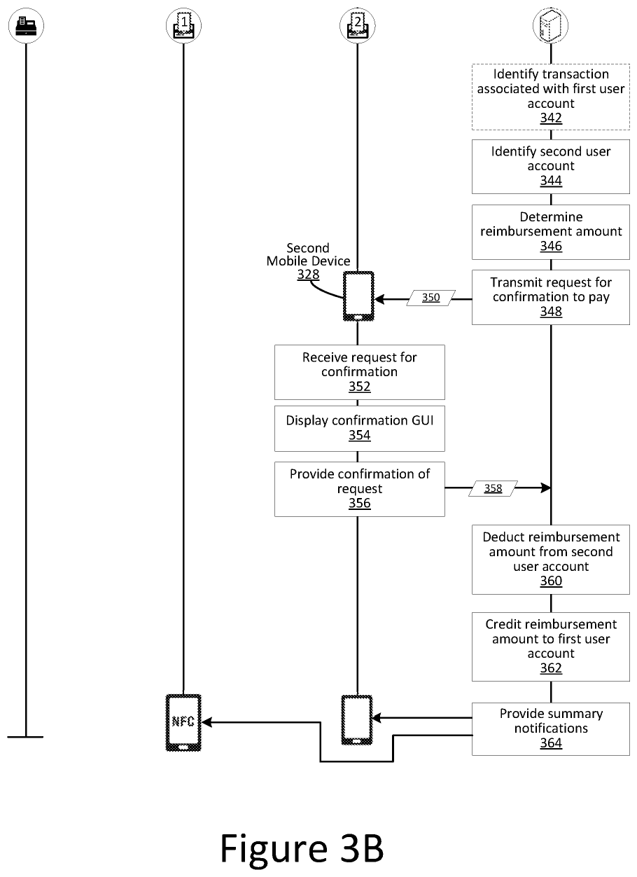

FIG. 3A illustrates a method for splitting a bill 300 in accordance with one example embodiment. According to some examples, a transaction may be initiated with a merchant (e.g., merchant 102) when a first payment instrument associated with a first user 302 is provided (310) to a POS device 308. The first payment instrument may include a first payment card 304 or a first mobile device 306, both of which are associated with a first user account (e.g., first user account 134). The first payment instrument may include a wireless communication module (e.g., NFC-enabled chip, NFC tag, Bluetooth transmitter, or similar short-range communication module) in order to facilitate wireless communication. During the transaction, POS device 308 may generate (312) transaction information 314 based on payment credentials as provided by the first payment instrument associated with first user 302. According to one example, the wireless communication module of the first payment instrument, including first mobile device 304 and/or first payment card 306, may be programmed to enter a search mode procedure after payment credentials have been provided. According to another example, search mode may be activated by an activation mechanism incorporated into payment instruments 304, 306, 326, and 328. Search mode as provided by the wireless communication module of the first payment instrument may include actively searching for other nearby wireless communication modules to read and store data therefrom.

POS device 308 transmits transaction information 314 over a network (e.g., network 110) to payment server 316. Payment server 316 receives transaction information 314, processes and authorizes (320) the transaction using transaction information 314 through payment service 318 (e.g., payment service 108). Payment server 316 further includes user accounts (e.g., user accounts 132) associated with users of payment service 318, including a first user account (e.g., first user account 134) associated with first user 302 and a second user account (e.g., second user account 136) associated with a second user 324.

Upon processing and authorizing the transaction, payment service 318 deducts the total cost of the transaction from the first user account and stores (322) transaction information 314 in a transaction activity log (e.g., transaction activity log 142) of the first user account on the data store (e.g., data store 128) of payment server 316 for later reference.

According to some examples, second user(s) 324 may include one or more users that wish to split the total cost of the recent transaction between first user 302 and the merchant. For the sake of discussion, second user(s) 324 may be referred to singularly as second user 324. Second user 324 may use a second payment instrument (e.g., second payment card 326, second mobile device 328) to interact with a first payment instrument (e.g., first mobile device 304, first payment card 306) of first user 302 in order to share data and initiate a splitting procedure or event.

The second payment instrument 326 and 328 may include a wireless communication module (e.g., NFC-enabled chip, NFC tag, Bluetooth transmitter, or similar short-range communication module) or other wireless communication element in order to facilitate a data exchange event using wireless communication. Interacting using wireless communication may include tapping, swiping, or alternatively activating a wireless communication module (e.g., NFC chip, Bluetooth transmitter) of a payment instrument of the associated user. According to some examples, the wireless communication module of the second payment instrument 326 and 328 may be programmed to enter search mode when an activation mechanism incorporated into the second payment instrument 326 and 328 is activated, as described above. Similarly, search mode as provided by the wireless communication module of the second payment instrument 326 and 328 may include searching for other nearby wireless communication modules to read and store data therefrom. Data provided using wireless communication may include, for example, identification data 332 associated with second user 324 and the associated second user account (e.g., second user account 136).

Second user 324 may interact with either of the first payment instruments associated with first user 302. For example, second user 324 may use second payment card 326 to interact with first payment card 306 acting as the first payment instrument in search mode as described above. In doing so, first payment card 306 reads (334) data from second payment card 326 using a wireless communication protocol. Accordingly, after reading data from second payment card 326, the wireless communication module of first payment card 306 transmits the read data to first mobile device 304 for further processing. As another example, first mobile device 304 may read (334) data from second payment card 326.

After receiving data by its wireless communication module, first mobile device 304 of first user 302 may transmit (336) to payment server 316 identification data 332 as read from second payment card 326. According to one example, first mobile device 304 may display (336) a confirmation graphical user interface (GUI) that prompts first user 302 to confirm the bill splitting procedure before transmitting (338) identification data 332 to payment server 316.

According to another example, identification data 332 may be transmitted to payment server 316 immediately after reading from second payment card 326. If identification data 332 is transmitted immediately, a notification requesting confirmation from first user 302 may be transmitted or otherwise initiated by payment processing service 318 for displaying on first mobile device 304 the confirmation GUI as described above. Using the confirmation GUI, first user 302 may provide a confirmation to payment service 318 on payment server 316.

After receiving identification data 332 from first mobile device 304, payment service 318 identifies (340) the first user account (e.g., first user account 134) associated with the first mobile device 304 and first user 302. Once the first user account is identified, payment service 318 further identifies (342) a recent transaction stored in the associated transaction activity log (e.g., transaction activity log 142) of the first user account intended to be split between users and may extract the associated transaction information (e.g., transaction information 314) therefrom, according to some examples.

Referring now to FIG. 3B, FIG. 3B illustrates a method for splitting a bill in accordance with one example embodiment. The method as illustrated in FIG. 3B is a continuation of the method of FIG. 3A. Payment service 318 uses identification data 332 to identify (344) a second user account (e.g., second user account 136) associated with identification data 332 and second user 324. Payment service 318 may use the previously-identified transaction information to determine (346) a reimbursement amount. Payment service 318 may determine a reimbursement amount according to data received from first mobile device 304, the transaction information, other data previously stored by the data store (e.g., data store 128) of payment service 318, or a combination thereof. For example, data received from first mobile device 304 may include a number of identification datum 332 received from first mobile device 304. Accordingly, if four (4) identification datum 332 are received from first mobile device 304, indicating four users wishing to split a recent transaction, the reimbursement amount may be determined by dividing the total cost as identified in the transaction information by four (or five, inclusive of the first user). As another example, the second user account may have stored therein an indication that first user 302 owes second user 324 five dollars ($5.00). Accordingly, payment service 318 may incorporate such debts into determining the reimbursement amount for second user 324, reducing the reimbursement amount by $5.00.

The reimbursement amount may also be intelligently determined according to data stored in the associated account of each user. For example, payment service 318 may determine a reimbursement amount for second user 324 based on transaction history stored in the transaction activity log (e.g., transaction activity log 144) of the associated second user account. The transaction history may be used by payment service 318 to determine which items in the identified transaction information are most likely correlated or otherwise similar to second user 324 prior purchase behavior at that merchant or other similar merchants. According to some examples, payment service 318 may further determine which items are least likely to be correlated to second user 324 based on the transaction history stored in the transaction activity log (e.g., transaction activity log 142) of other users, including that of first user 302. In doing so, payment service 318 may determine the reimbursement amount for second user 324 to be the total cost of the items identified as most likely to be items for the second user 324 and the associated transaction history thereof.

As another example, payment service 318 may determine a reimbursement amount for second user 324 based on an individual preference profile stored in the associated second user account. The preference profile of the second user account may include a trained model or other data indicative of patterns in the transaction activity log. Accordingly, the preference profile may be trained using prediction algorithms or other machine learning models that reflect what second user 324 may be most likely to purchase. Payment service 318 may use such a preference profile to determine which items identified in the transaction information are most likely correlated to second user 324. Payment service 318 may further determine which items are least likely to be correlated to second user 324 based on the preference profiles of other users. In doing so, payment service 318 may determine the reimbursement amount for second user 324 to be the total cost of the items identified as most likely correlated to second user 324 and the associated preference profile thereof.

As yet another example, payment service 318 may determine a reimbursement amount for second user 324 based on a probability map. The probability map for second user 324 indicates which of the items in the identified transaction information are most likely and least likely to be correlated to second user 324. In doing so, payment service 318 may determine the reimbursement amount for second user 324 to be the total cost of the items identified as most likely correlated to second user 324 by the probability map, preference profile, transaction history, or a combination thereof, among other data stored in the data store of payment service 318. The probability map may also be determined using data in the data store of payment service 318 associated with other users, such as the preference profile or transaction history of the first user 302. According to some examples, the probability map may be generated dynamically for each reimbursement amount determined by payment service 318. The probability map may also be stored in the data store of payment service 318 for later use in determining other probability maps or reimbursement amounts at a future time.

According to some examples, payment service 318 may transmit to first mobile device 304 of first user 302 a request to confirm or otherwise update each reimbursement amount as determined by payment service 318. Upon receiving the request, first mobile device 304 may provide for first user 302 a GUI that displays each reimbursement amount as determined by payment service 318. First user 302 may confirm or otherwise update each reimbursement amount as needed. Once first user 302 has completed confirming or revising the reimbursement amount(s) displayed by the GUI, first mobile device 304 may transmit an indication of the reimbursement amounts as provided by the first user, if any. This indication may include updated reimbursement amount(s), confirmation of reimbursement amount(s), or a combination thereof.

Payment service 318 may transmit (348) to a second mobile device 328 associated with second user 324 a notification to request to pay 350 the determined reimbursement amount. Second mobile device 328 may receive (352) the notification to request to pay 350 and generate a confirmation graphical user interface (GUI) according to the notification request 350. Second mobile device 328 may display (354) the confirmation GUI that prompts second user 324 to confirm paying the determined reimbursement amount. Second user 324 may confirm (356) the request using the GUI of second mobile device 328. After second user 324 confirms, second mobile device 328 provides a confirmation 358 to payment service 318 on payment server 316.

Payment service 318, upon receiving confirmation 356 from second mobile device 328, deducts (360) the reimbursement amount from the second user account associated with second user 324 and credits (362) the reimbursement amount to the first user account associated with first user 302. Once the reimbursement amount has been deducted and credited accordingly, payment service 318 may notify first user 302 and second user 324. According to some examples, a notification summarizing the transfer of funds from the second user account to the first user account are provided (364) by payment service 318 to first mobile device 304 and second mobile device 328. Alternative notifications may also be provided to first user 302 and second user 324 using other communication methods (e.g., email, SMS/MMS message(s), etc.).

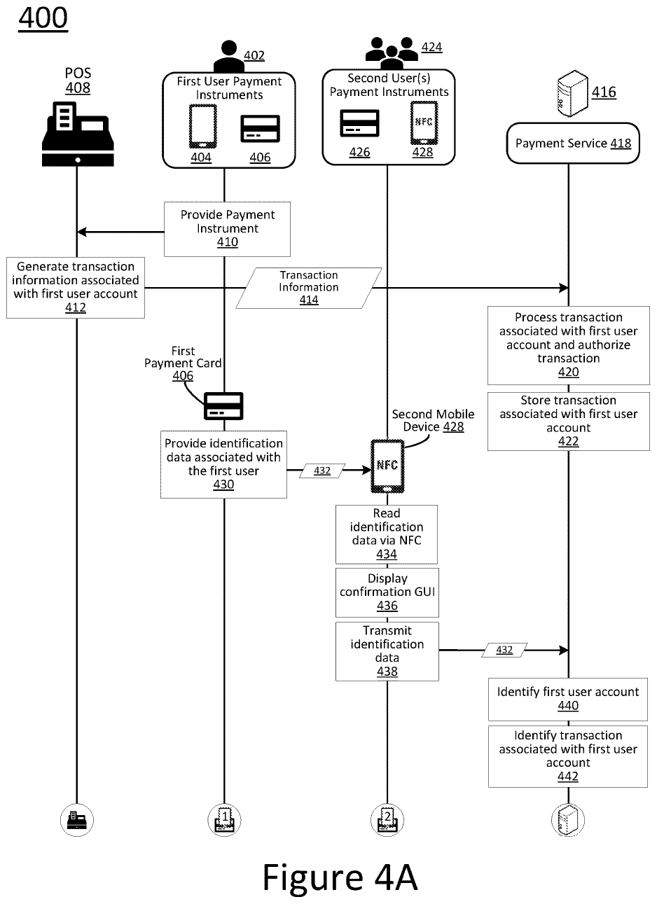

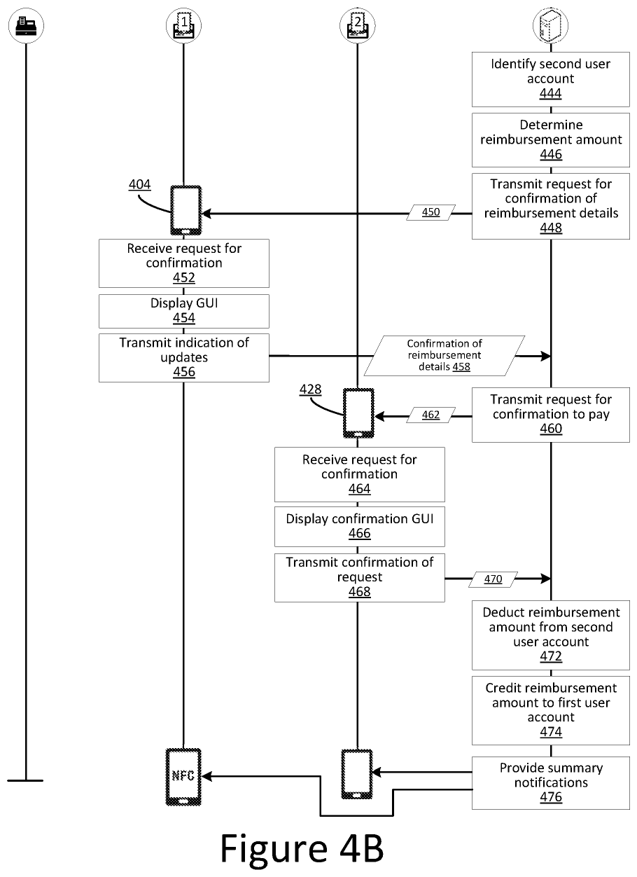

FIG. 4A illustrates a method for splitting a bill 400 in accordance with one example embodiment. According to some examples, a transaction may be initiated with a merchant when a first payment instrument associated with a first user 402 is provided (410) to a POS device 408. The first payment instrument may include a first payment card 404 or a first mobile device 406, both of which are associated with a first user account (e.g., first user account 134). The first payment instrument may include a wireless communication module (e.g., NFC-enabled chip, NFC tag, Bluetooth transmitter, or similar short-range communication module) in order to facilitate wireless communication. During the transaction, POS device 408 may generate (412) transaction information 414 based on payment credentials as provided by the first payment instrument associated with first user 402. According to one example, the wireless communication module of the first payment instrument, including first mobile device 404 and/or first payment card 406, may be programmed to activate a search mode procedure after payment credentials have been provided. According to another example, search mode may be activated by an activation mechanism incorporated into the payment instrument 404, 406, 426, and 428.

Search mode as provided by the wireless communication module of the first payment instrument may include searching for other nearby wireless communication modules to read and store data therefrom.

POS device 408 transmits transaction information 414 over a network to payment server 416. Payment server 416 receives transaction information 414 and processes and authorizes (420) the transaction using transaction information 414 through payment service 418 (e.g., payment service 108). Payment server 416 further includes user accounts (e.g., user accounts 132) associated with users of payment service 418, including a first user account (e.g., first user account 134) associated with first user 402 and a second user account (e.g., second user account 134) associated with a second user 424.

By processing and authorizing (420) the transaction, payment service 418 deducts the total cost of the transaction from the first user account and, thereby, stores (422) transaction information 414 in a transaction activity log (e.g., transaction activity log 142) of the first user account on the data store (e.g., data store 128) of payment server 416 for later reference.

According to some examples, second user(s) 424 may include one or more users that wish to split the total cost of the recent transaction between first user 402 and the merchant. For the sake of discussion, second user(s) 424 may be referred to singularly as second user 424. Second user 424 may use a second payment instrument (e.g., second payment card 426, second mobile device 428) to interact with a first payment instrument (e.g., first mobile device 404, first payment card 406) of first user 402 in order to share data and initiate a splitting procedure or event. The second payment instrument may include a wireless communication module (e.g., NFC-enabled chip, NFC tag, Bluetooth transmitter, or similar short-range communication module) in order to facilitate a data exchange event using wireless communication. Interacting using a wireless communication protocol may include tapping, swiping, or alternatively activating a wireless communication module (e.g., NFC chip) of a payment instrument of the associated user. According to some examples, the wireless communication module of the second payment instrument, including second payment card 426 and/or second mobile device 428, may be programmed to enter search mode by an activation mechanism incorporated into the second payment instrument as described above. Similarly, search mode as provided by the wireless communication module of the second payment instrument may include sniffing for other nearby wireless communication modules to read and store data therefrom. Data provided using a wireless communication protocol may include, for example, identification data 432 associated with first user 402 and the associated first user account (e.g., first user account 134).

Second user 424 may interact with either of the first payment instruments associated with first user 402. For example, second user 424 may activate search mode as described above by an activation mechanism incorporated into second payment card 426 to interact with first payment card 406. In doing so, second payment card 406 reads (434) data from first payment card 406 using a wireless communication protocol. Accordingly, after reading data from first payment card 406, the wireless communication module of second payment card 426 transmits the read data to second mobile device 428 for further processing. As another example, second mobile device 428 may read (434) data from first payment card 406.

After reading data using a wireless communication protocol, second mobile device 428 of second user 424 may transmit to payment server 416 identification data 432 as read from first payment card 406. According to one example, second mobile device 428 may display (436) a confirmation GUI that prompts second user 424 to confirm the bill splitting procedure before transmitting (438) identification data 432 to payment server 416. According to another example, identification data 432 may be transmitted to payment server 416 immediately after reading from first payment card 406. If identification data 432 is transmitted immediately, a notification requesting confirmation from second user 424 may be transmitted or otherwise initiated by payment service 418 for displaying on first mobile device 428 the confirmation GUI as described above. Using the confirmation GUI, second user 424 may provide confirmation to payment service 418 on payment server 416.

After receiving identification data 432 from second mobile device 428, payment service 418 uses identification data 432 to identify (440) a first user account (e.g., first user account 134) associated with the first user 402. Once the first user account is identified, payment service 418 further identifies (442) a recent transaction stored in the associated transaction activity log (e.g., transaction activity log 142) of the first user account 466 that is intended to be split between users. Payment service 418 may then extract the associated transaction information (e.g., transaction information 414) from the recent transaction, according to some examples.

Referring now to FIG. 4B, FIG. 4B illustrates a method for splitting a bill in accordance with one example embodiment. The method as illustrated in FIG. 4B is a continuation of the method of FIG. 4A. Payment service 418 may further identify (444) the second user account associated with the second mobile device 428 and second user 424. Payment service 418 may use the extracted transaction information (e.g., transaction information 414) to determine (446) a reimbursement amount. According to some examples, payment service 418 may determine a reimbursement amount according to data received from second mobile device 428, the transaction information, other data previously stored by the data store (e.g., data store 128) of payment service 418, or a combination thereof. For example, payment server 418 may receive identification datum 432 associated with first user 402 from a number of mobile devices (e.g., second mobile device 428). Accordingly, if the identification datum 432 is received from three (3) mobile devices, the reimbursement amount may be determined by dividing the total cost as identified in the transaction information by three (or four, inclusive of the first user). As another example, the second user account may have stored therein an indication that first user 402 owes second user 424 four dollars ($4.00). Accordingly, payment service 418 may incorporate such debts into determining the reimbursement amount for second user 424, reducing the reimbursement amount by $4.00.

The reimbursement amount may be intelligently determined using data stored in the associated account of each user. For example, payment service 418 may determine a reimbursement amount for second user 424 based on transaction history stored in the transaction activity log (e.g., transaction activity log 144) of the associated second user account. The transaction history may be used by payment service 418 to determine which items in the transaction information are most likely correlated to or most likely for second user 424.

According to some examples, payment service 418 may further determine which items are least likely to be correlated to second user 424 based on the transaction history stored in the transaction activity log (e.g., transaction activity log 142) of other users, including that of first user 402. In doing so, payment service 418 may determine the reimbursement amount for second user 424 to be the total cost of the items identified as most likely to be items for the second user 424 and the associated transaction history thereof.

As another example, payment service 418 may determine a reimbursement amount for second user 424 based on an individual preference profile stored in the associated second user account. The preference profile of the second user account may include a trained model or other data indicative of patterns in the transaction activity log. Accordingly, the preference profile may be trained using prediction algorithms or other machine learning models that reflect what second user 424 may be most likely to purchase. Payment service 418 may use such a preference profile to determine which items identified in the transaction information are most likely correlated to second user 424. Payment service 418 may further determine which items are least likely to be correlated to second user 424 based on the preference profiles of other users. In doing so, payment service 418 may determine the reimbursement amount for second user 424 to be the total cost of the items identified as most likely correlated to second user 424 and the associated preference profile thereof.

As yet another example, payment service 318 may determine a reimbursement amount for second user 424. The probability map determined for second user 424 indicates which of the items in the identified transaction information are most likely and least likely to be correlated to second user 424. In doing so, payment service 418 may determine the reimbursement amount for second user 424 to be the total cost of the items identified as most likely correlated to second user 424 by the probability map, preference profile, transaction history, or a combination thereof, among other data stored in the data store of payment service 418. The probability map may also be determined using data in the data store of payment service 418 associated with other users, such as the preference profile or transaction history of the first user 402. According to some examples, the probability map may be generated dynamically for each reimbursement amount determined by payment service 418. The probability map may also be stored in the data store of payment service 418 for later use in determining other probability maps or reimbursement amounts at a future time.

According to some examples, payment service 418 may transmit (448) to a first mobile device 404 associated with first user 402 a notification request 450 to confirm or otherwise update each determined reimbursement amount along with associated details thereto. The associated details included in notification request 450 may include an indication of the second user account associated with the second user 424. First mobile device 404 may receive (452) the notification request 450 and generate a GUI according to the notification request 450. The GUI may be transmitted or otherwise initiated by payment processing service 418. The confirmation GUI may be displayed (454) on first mobile device 404 for first user 402, displaying each reimbursement amount as determined by payment service 418. First user 402 may confirm or otherwise update each reimbursement amount as needed. Once first user 402 has completed confirming or revising the reimbursement amount(s) displayed by the GUI, first mobile device 404 may transmit (456) an indication of the reimbursement amounts as provided by the first user 402 to payment service 418. This indication may include updated reimbursement amount(s), confirmation of reimbursement amount(s), or a combination thereof.

Payment service 418 may further transmit (460) back to second mobile device 428 associated with second user 424 a notification request 462 to pay the reimbursement amount as confirmed or otherwise updated by first user 402, according to some examples. Second mobile device 428 may receive (464) the notification request 462 and generate a confirmation GUI according to the notification request 462. According to some examples, the confirmation GUI may be transmitted or otherwise initiated by payment service 418. The confirmation GUI may be displayed (466) on second mobile device 428 for second user 424. Second user 424 may confirm the request using the GUI of second mobile device 428. Upon second user 424 confirming the request, second mobile device 428 transmits (468) a confirmation 470 to payment service 418 on payment server 416.

Payment processing service 418, upon receiving confirmation 470 from second mobile device 428, deducts (472) the reimbursement amount from the second user account associated with second user 424 and credits (474) the reimbursement amount to the first user account associated with first user 402. Once the reimbursement amount has been deducted and credited accordingly, payment service 418 may notify first user 402 and second user 424. According to some examples, a notification summarizing the transfer of funds from the second user account to the first user account is provided (476) by payment service 418 to first mobile device 404 and second mobile device 428. Alternative notifications may also be provided to first user 402 and second user 424 using other communication methods (e.g., email, SMS/MMS message(s), etc.), according to some examples.

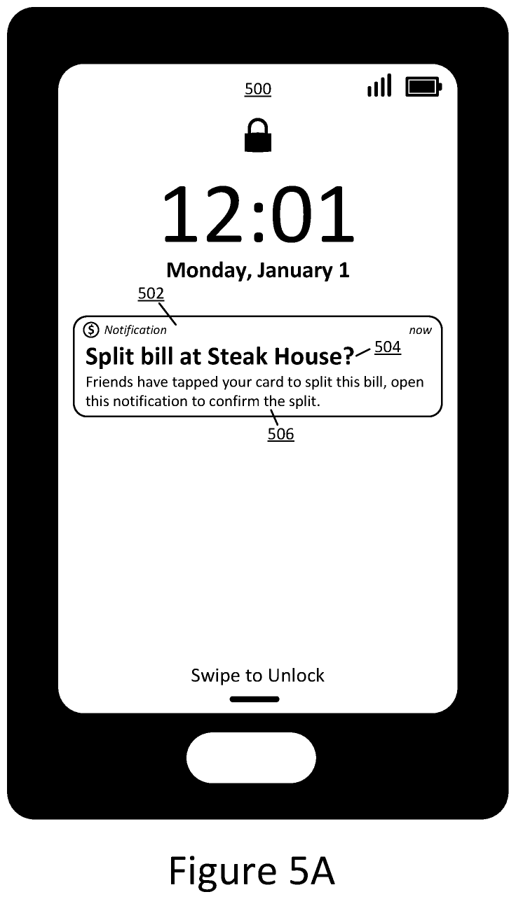

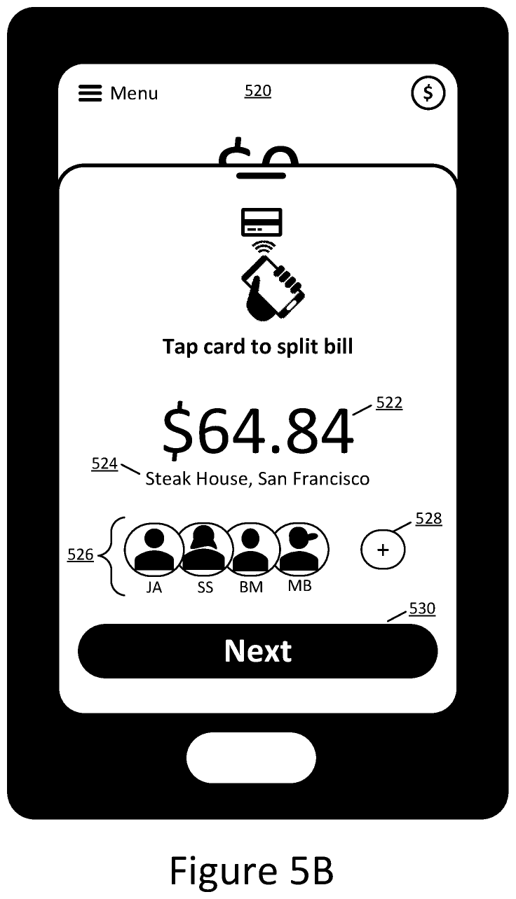

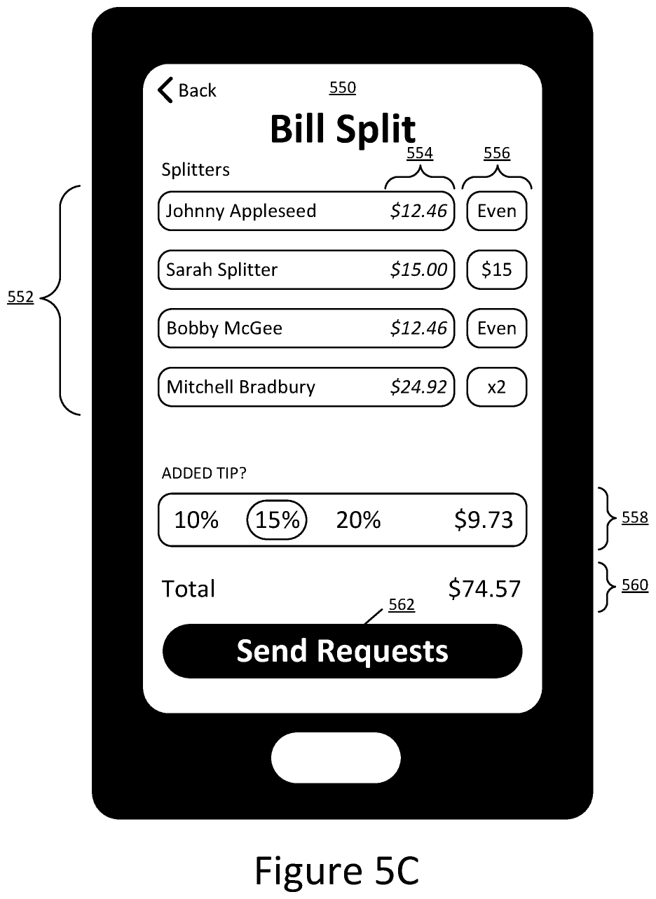

FIG. 5A illustrates a graphical user interface in accordance with one example embodiment. GUI 500 may display a notification 502 on a first mobile device of a first user (e.g., first user 152, first user 302, first user 402) who wishes to split a recent transaction with one or more second users (e.g., second user(s) 156, second user(s) 324, second user(s) 424).

Notification 502 may be displayed on the first mobile device after receiving a request (e.g., notification request 450) from a payment service (e.g., payment service 108, payment service 318, payment service 418). Notification 502 may indicate or otherwise display information associated with the recent transaction intended to be split. For example, notification 502 displays an indication 504 of the location at which the transaction took place, reading “Steak House” as shown in FIG. 5A. Notification 502 may further display an indication 506 that a split procedure has been initiated. For example, notification 502 displays an indication 506 that one or more second users have interacted with the first payment card associated with the first user, reading “Friends have tapped your card to split this bill, open this notification to confirm the split” as shown in FIG. 5A. According to some examples, interacting with notification 502 may provide shortcut controls provided by the operating system executing on the first mobile device.

Interacting with notification 502 may also open the application (e.g., payment application 204) associated with notification 502. Interacting with notification 502 may also display for the first user a start page of the split procedure (e.g., FIG. 5B), according to some examples.

FIG. 5B illustrates a graphical user interface in accordance with one example embodiment. GUI 520 may be displayed (e.g., display confirmation GUI 336, display confirmation GUI 436) on a first mobile device of a first user who wishes to split a recent transaction with one or more second users. GUI 520 may be displayed on the first mobile device after receiving identification data (e.g., identification data 332) associated with a second user or the first user, according to some examples. GUI 520 may also be displayed on the first mobile device after receiving a request for confirmation of reimbursement details (e.g., notification request 450) from a payment service (e.g., payment service 108, payment service 318, payment service 418). GUI 520 may also be displayed on the first mobile device after the first user selects a button on the first mobile device that, when selected, displays GUI 520.

GUI 520 may include indications of the received transaction information (e.g., transaction information 314, transaction information 414), such as the cost of the transaction 522 and merchant details 504. GUI 520 may also include indications of reimbursement details, including representations of one or more second users. GUI 520 may further include user identifiers 526 representative of the second users and details (e.g., user account images, user account names) associated with their respective user accounts. User identifiers 526 may be populated automatically. For example, if a second user provides identification data to the first mobile device or the payment card of the first user via a wireless communication protocol, GUI 520 may populate user identifiers 526 with another individual user identifier representative of the second user. As another example, when the first user provides identification data to a payment service using a second mobile device, the payment service may initiate GUI 520 to populate user identifiers 526 with another individual user identifier representative of the second user associated with the second mobile device.

User identifiers 526 may be added, altered, or otherwise edited by the first user. For example, GUI element 528, when selected, may allow editing of the user identifiers 526. Editing may include adding or removing user identifiers. GUI 520 may further include a next button 530, which, when selected, may display for the first user a summary page of the split procedure (e.g., FIG. 5C).

FIG. 5C illustrates a graphical user interface in accordance with one example embodiment. GUI 550 may be displayed on the first mobile device after GUI 520. According to some examples, GUI 550 may be displayed instead of GUI 520. GUI 550 may include a second users list 552 representative of the one or more second users and details associated with their respective user accounts. Second users list 552 may include the same users indicated by user identifiers 526 of GUI 520. According to some examples, second users list 552 may include more or less users as indicated by user identifiers 526 of GUI 520, according to some examples. Second users list 552 may further include a reimbursement amount 554 determined for each individual user of second users list 552.

GUI 550 may further include reimbursement shortcuts 556, each of which may be associated with each individual user of second users list 552. Reimbursement shortcuts 556 may include various shorthand indicators to assist the first user with determining a reimbursement amount 554 for each user of second users list 552. When selected, each of the reimbursement shortcuts 556 may display for the first user one or more shorthand indicators, including, but not limited to “Even”, “x2”, “½”, item-based, among others. When changed, reimbursement shortcuts 556 may alter the reimbursement amount 554 as indicated by the associated individual user of the list of users 552. Reimbursement shortcuts 556 and the associated shorthand indicators may be auto-populated based on how each associated reimbursement amount was determined. For example, the payment service may intelligently determine which item of the transaction is associated with each user as displayed by second users list 552. The items of the transaction may be matched to each of the second users list 552 based on the transaction history or preference profile of each user account associated with each user. According to some examples, item-based shorthand indicators may be populated in reimbursement shortcuts 556.

GUI 550 may further include a tip tool 558. According to some examples, tip tool 558 may include suggested tip percentages selectable by the first user and, in turn, display for the first user a calculated tip amount based on the selected suggested tip percentage. Tip tool 558 may also allow the first user to manually enter a tip amount without selecting a suggested tip percentage. GUI 550 further includes a total 560, which displays for the first user the sum of the tip amount (e.g., from tip tool 558) and cost of the transaction (e.g., 522). Total 560 may dynamically change based on the other elements of GUI 550, such as changes made to tip tool 558. GUI 550 may further include a send button 562 that, when selected, may transmit to the payment server a confirmation (e.g., confirmation 470), including the user accounts as displayed by second users list 552 and their associated reimbursement amounts 554. According to some examples, other information may be transmitted to the payment server, another device, or a plurality of other devices when send button 562 is selected.

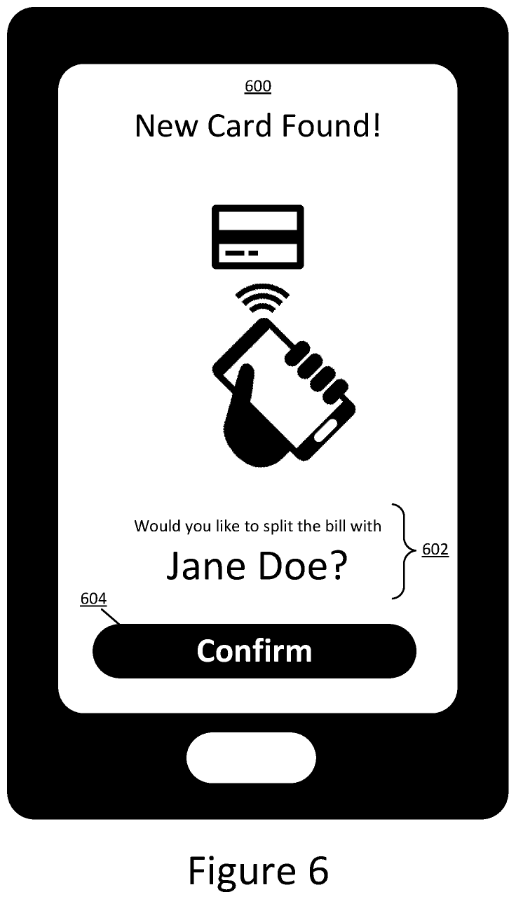

FIG. 6 illustrates a graphical user interface in accordance with one example embodiment. GUI 600 may be displayed when a second user (e.g., second user 156, second user 324, second user 424) initiates a data transfer between the second mobile device (e.g., second mobile device 158, second mobile device 328, and second mobile device 428) and a first payment card enabled with NFC technology. According to some examples, GUI 600 may also be displayed when a second user initiates a data transfer between a second payment instrument of the second user and a first payment instrument of a first user. This data transfer may include identification data associated with the second user, according to some examples. Alternatively, GUI 600 may be displayed when a request to split a transaction is received from another device, including another mobile device, a POS device, or a payment server, according to some examples. GUI 600 may include an indication 602 requesting whether the second user would like to split a transaction. Indication 602 may include data indicative of the first user to be paid, other users splitting the transaction, the total reimbursement amount, details associated with the reimbursement amount, the merchant name, the location of the transaction, or any other data representative of the transaction information, according to some examples. GUI 600 may further include a confirm button 604 that, when selected, may transmit confirmation (e.g., confirmation 358, confirmation 470) to a payment server. According to some examples, other information may be transmitted to the payment server, another device, or a plurality of other devices when confirm button 604 is selected; other information including, but not limited to: second user account information, identification data associated with the first user account and/or the second user account, reimbursement amount, details associated with the reimbursement amount, or any other information related to transaction information.

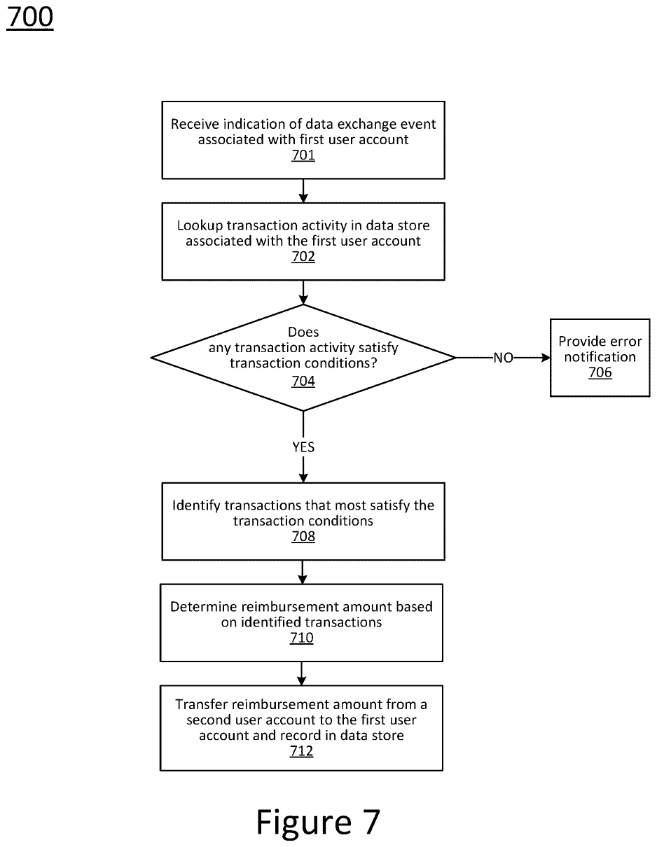

FIG. 7 illustrates a flow chart 700 of the split payment system in accordance with one example embodiment. In step 701, the payment server receives an indication of a data exchange event with a first payment instrument associated with a first user account of a first user. In one example, the data exchange event involves a second user tapping their payment card on the payment instrument of the first user so that data is exchanged via a short range wireless communication protocol (e.g. NFC). In step 702, the payment server determines transaction activity associated with the first user account based on a lookup in the data store maintained by the payment service. In step 704, the payment server determines whether any transaction activity associated with the first user satisfies transaction conditions for a split payment (e.g. occurring within threshold period of time from the data exchange event, and relates to the purchase of goods or services). If no transaction activity satisfies the transaction conditions, the payment server, in step 706, may provide a notification to one or more users that an error has occurred.

Otherwise, the payment server identifies a transaction from the transaction activity that most satisfies the transaction conditions for a split payment at step 708. For example, the payment server can identify that the first user recently made a transaction within the last 15 minutes at a particular restaurant and determine from a probability scoring algorithm that this transaction is related to the desired split payment request. Upon determining and identifying a transaction that satisfies transaction conditions for split payment, in step 710, the payment server determines a reimbursement amount based on the identified transaction activity associated with the first user account. As mentioned above with respect to FIG. 4B, the reimbursement amount may be determined by the payment server in several different ways. In step 712, the payment server facilitates a transfer of funds corresponding to the reimbursement amount from the second user account to the first user account and updates the respective balances of each user account.

The present system may also be used to split a payment for a good or service purchased through a mobile application or website for a merchant (e.g., Amazon, Macy's, etc.). According to one example, two coworkers may want to split the cost of a birthday gift for a friend. The coworkers may both be in the same place (e.g., at work, etc.) that is not at a physical location for a merchant. After the first coworker completes the purchase on the mobile application or website, the second coworker taps her payment instrument on the first coworker's mobile device (or to the first coworker's payment card) used to purchase the gift. More specifically, a first user 302, 402 provides a payment instrument (e.g., payment instrument 304, 306, payment instrument 404, 406) to the merchant website or application. The first user 302, 402 may also manually enter payment credentials into the merchant website or application, or otherwise may pass payment credentials into the merchant website or application using a payment application (e.g., payment application 204) executing on the first user's computing device (e.g., first mobile device 154, mobile device 202, mobile device 304, mobile device 404). Payment credentials may also be passed into the website or application using a third-party payment application (e.g., Apple Pay®, Google Pay™, Samsung Pay®, Alipay™, etc.) executing on the first user's computing device. Once the first user payment instrument has been provided to the merchant application or website, the bill split process continues as shown in bill split method 300 of FIG. 3A by generating transaction information with the first user account (312). According to another example, once the first user payment instrument has been provided to the merchant application or website, the bill split process continues as shown in bill split method 400 of FIG. 4A by generating transaction information with the first user account (412).

According to another example, two coworkers may want to split the cost of a birthday gift for a friend. The coworkers may both be shopping together at a store in a mall. When they see a gift that they wish to purchase, the first coworker scans a barcode or QR code for the gift, which launches an application or website to complete the purchase of the gift. The gift may be shipped to the recipient by the merchant in this example. In another example, the coworkers leave the store with the gift. In these examples, once the first user payment instrument has been provided to the merchant application or website and the second coworker taps their payment instrument on the first coworker's mobile device or payment card, the bill split process continues as shown in bill split method 300 of FIG. 3A by generating transaction information with the first user account (312). According to another example, once the first user payment instrument has been provided to the merchant application or website and the second coworker taps their payment instrument on the first coworker's mobile device or payment card, the bill split process continues as shown in bill split method 400 of FIG. 4A by generating transaction information with the first user account (412).

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some examples, a service can be software that resides in memory of a client device and/or one or more servers of a content management system and perform one or more functions when a processor executes the software associated with the service. In some examples, a service is a program, or a collection of programs that carry out a specific function. In some examples, a service can be considered a server. The memory can be a non-transitory or transitory computer-readable medium.

In some examples the computer-readable storage devices, mediums, and memories can include a cable or wireless signal containing a bit stream and the like. However, when mentioned, transitory computer-readable storage media are media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Having now fully set forth examples and certain modifications of the concept underlying the present invention, various other examples as well as certain variations and modifications of the examples shown and described herein will obviously occur to those skilled in the art upon becoming familiar with said underlying concept.

1. A method of reducing exposure and manual input of sensitive information in association with transactions between users, the method comprising:
receiving, by an application on a mobile device of a first user, an indication that a financial transaction has been processed for a bill between a first user and a merchant using the mobile device and a point-of-sale device of the merchant, wherein the bill is processed on behalf of the first user;
displaying, by the application at the mobile device, a user interface presenting an amount, the amount being a portion of the bill for which a second user is responsible;
responsive to receiving a user selection of a button at the mobile device, presenting, by the application at the mobile device, an indication on the user interface to tap a physical instrument to the mobile device to conduct a transaction which utilizes the physical instrument to pay for the amount, wherein the physical instrument is associated with the second user;
activating a short range wireless communication module of the mobile device to read data from nearby wireless communication modules;
based on a tap of the physical instrument to the mobile device, wirelessly reading identifier information of the physical instrument from a wireless communication module of the physical instrument using the short range wireless communication module of the mobile device;
communicating, by the mobile device of the first user, the identifier information to a payment server to initiate processing of a reimbursement for a portion of the bill associated with the second user;
receiving authorization from the payment server to process the reimbursement between a first account associated with the physical instrument and a second account associated with the mobile device based on the read identifier information; and
initiating, by the application, the transaction between the first account and the second account.

2. The method of claim 1, further comprising providing a notification summarizing the transaction to the first account.

3. The method of claim 2, wherein the notification summarizing the transaction is provided to the first account via one of an email associated with the first account or via a SMS/MMS message to the mobile device.

4. (canceled)

5. The method of claim 1, wherein the short range wireless communication module of the mobile device utilizes near field communication (NFC) to wirelessly read the identifier information of the physical instrument from the wireless communication module of the physical instrument.

6. The method of claim 1, wherein the short range wireless communication module of the mobile device utilizes a protocol for NFC data exchange format (NDEF) to wirelessly read the identifier information of the physical instrument from the wireless communication module of the physical instrument.

7. The method of claim 1, wherein the physical instrument is a card and the short range wireless communication module of the physical instrument comprises an NFC-enabled chip.

8. The method of claim 1, wherein activating the short range wireless communication module of the mobile device includes activating a search mode to sniff for the nearby wireless communication modules to read and store data from the nearby wireless communication modules.

9. A mobile device comprising:
a short range wireless communication module configured to read data from nearby wireless communication modules; and
one or more processors to execute instructions of an application to:
receive, via an application on the mobile device, an indication that a financial transaction has been processed for a bill between a first user and a merchant using the mobile device and a point-of-sale device of the merchant, wherein the bill is processed on behalf of the first user;
display a user interface presenting an amount, the amount being a portion of the bill for which a second user is responsible;
responsive to receiving a user selection of a button, present an indication on the user interface to tap a physical instrument to the mobile device to conduct a transaction which utilizes the physical instrument to pay for the amount, wherein the physical instrument is associated with the second user;
based on a tap of the physical instrument to the mobile device, wirelessly read identifier information of the physical instrument from a wireless communication module of the physical instrument using the short range wireless communication module;
communicate, by the mobile device, the identifier information to a payment server to initiate processing of a reimbursement for a portion of the bill associated with the second user;
receive authorization from the payment server to process the reimbursement between a first account associated with the physical instrument and a second account associated with the mobile device based on the read identifier information; and
initiate the transaction between a first account associated with the physical instrument and a second account associated with the mobile device based on the read identifier information.

10. The mobile device of claim 9, wherein the one or more processors are further configured to provide a notification summarizing the transaction to the first account.

11. The mobile device of claim 10, wherein the notification summarizing the transaction is provided to the first account via an email associated with the first account.

12. The mobile device of claim 10, wherein the notification summarizing the transaction is provided via SMS/MMS message to a user device associated with the first account.

13. The mobile device of claim 9, wherein the short range wireless communication module of the mobile device is configured to utilize near field communication (NFC) to wirelessly read the identifier information of the physical instrument from the wireless communication module of the physical instrument.

14. The mobile device of claim 9, wherein the short range wireless communication module of the mobile device is configured to utilize a protocol for NFC data exchange format (NDEF) to wirelessly read the identifier information of the physical instrument from the wireless communication module of the physical instrument.

15. The mobile device of claim 9, wherein the physical instrument is a card and the short range wireless communication module of the physical instrument comprises an NFC-enabled chip.

16. The mobile device of claim 9, wherein the one or more processors are further configured to activate the short range wireless communication module of the mobile device, including activating a search mode to sniff for the nearby wireless communication modules to read and store data from the nearby wireless communication modules.

17. The mobile device of claim 9, wherein the mobile device is a mobile phone.

18. Non-transitory computer-readable storage media storing computer-readable instructions, which when executed by one or more processors of a mobile device, cause the mobile device to:
receive, via an application on the mobile device, an indication that a financial transaction has been processed for a bill between a first user and a merchant using the mobile device and a point-of-sale device of the merchant, wherein the bill is processed on behalf of the first user;
display a user interface presenting an amount, the amount being a portion of the bill for which a second user is responsible;
responsive to receiving a user selection of a button, present an indication on the user interface to tap a physical instrument to the mobile device to conduct a transaction which utilizes the physical instrument to pay for the amount, wherein the physical instrument is associated with the second user;
activate a short range wireless communication module of the mobile device to read data from nearby wireless communication modules;
based on a tap of the physical instrument to the mobile device, wirelessly read identifier information of the physical instrument from a wireless communication module of the physical instrument using the short range wireless communication module;
communicate, by the mobile device, the identifier information to a payment server to initiate processing of a reimbursement for a portion of the bill associated with the second user;
receive authorization from the payment server to process the reimbursement between a first account associated with the physical instrument and a second account associated with the mobile device based on the read identifier information; and
initiate the transaction between a first account associated with the physical instrument and a second account associated with the mobile device based on the read identifier information.

19. The non-transitory computer-readable storage media of claim 18, wherein execution of the computer-readable instructions further cause the mobile device to provide a notification summarizing the transaction to the first account.

20. The non-transitory computer-readable storage media of claim 19, wherein the notification summarizing the transaction is provided to the first account via at least one of an email or SMS/MMS message to a user device associated with the first account.

21. The method of claim 1, wherein the identifier information of the physical instrument is transferred directly from the physical instrument to the mobile device locally without utilizing a connection with the payment server.
